(19) United States
(12) Patent Application Publication
(10) Pub. No.: US 2023/0331327 A1
(43) Pub. Date: Oct. 19, 2023

(54) COLLAPSIBLE BICYCLE

(71) Applicant: TUNG KENG ENTERPRISE CO., LTD., Taichung (TW)

(72) Inventor: CHIU-HSIANG LO, TAICHUNG (TW)

(21) Appl. No.: 17/722,388

(22) Filed: Apr. 18, 2022

(51) Int. Cl. B62H 5/00; B62K 15/00

(52) U.S. Cl. CPC B62H 5/00; B62K 15/006

(57) ABSTRACT

A collapsible bicycle includes a collapsible tube, a spring-loaded detent, a rod, a hook, and a security element. The collapsible tube includes a first section, a second section, and a hinge for pivotally connecting the first and second sections to each other. The spring-loaded detent is connected to the second section of the collapsible tube and formed with an external end. The rod is connected to the second section of the collapsible tube. The hook is pivotally connected to the first section and formed with a hook engageable with the rod to keep the first and second sections of the collapsible tube coaxial with each other. The security element is pivotally connected to the first section of the collapsible tube and formed with a concave portion for receiving the spring-loaded detent to keep the security element covering the hook, thereby keeping the hook engaged with the rod.

### BACKGROUND OF INVENTION

### 1. Field of Invention

The present invention relates to a bicycle and, more particularly, to a collapsible bicycle.

### 2. Related Prior Art

A collapsible bicycle occupies a reduced volume when it is collapsed. Thus, the collapsible bicycle is convenient for transportation and/or storage. To this end, a typical collapsible bicycle includes a collapsible top tube, a collapsible seat post, and a collapsible steerer. Each of the collapsible top tube, seat post and steerer includes two sections pivotally connected to each other by a hinge. Thus, the sections are located side by side when the collapsible top tube, seat post or steerer is collapsed. Thus, the sections are coaxial when the collapsible top tube, seat post or steerer is extended. The collapsible top tube, seat post or steerer is retained in the extended position by a locking device. A typical locking device includes a hook and a rod. The hook is pivotally connected to one of the sections, and the rod is securely connected to the remaining one of the sections. The hook is engaged with the rod to keep the sections in position. However, the hook can be disengaged from the rod accidentally. It is difficult to render the locking device both convenient and secure.

Therefore, the present invention is intended to obviate or at least alleviate the problems encountered in the prior art.

### SUMMARY OF INVENTION

It is the primary objective of the present invention to provide a reliable collapsible bicycle.

To achieve the foregoing objective, the collapsible bicycle includes a collapsible tube, a spring-loaded detent, a rod, a hook, and a security element. The collapsible tube includes a first section, a second section, and a hinge for pivotally connecting the first and second sections to each other. The spring-loaded detent is connected to the second section of the collapsible tube and formed with an external end. The rod is connected to the second section of the collapsible tube. The hook is pivotally connected to the first section and formed with a hook engageable with the rod to keep the first and second sections of the collapsible tube coaxial with each other. The security element is pivotally connected to the first section of the collapsible tube and formed with a concave portion for receiving the spring-loaded detent to keep the security element covering the hook, thereby keeping the hook engaged with the rod.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a locking device according to the preferred embodiment of the present invention;

FIG. 2 is another exploded view of the locking device shown in FIG. 1 and a portion of a collapsible bicycle;

FIG. 3 is a perspective view of the locking device shown in and the portion of the collapsible bicycle shown in FIG. 2;

FIG. 4 is a cross-sectional view of the locking device and the portion of the collapsible bicycle shown in FIG. 3;

FIG. 5 is a side view of the locking device and the portion of the collapsible bicycle shown in FIG. 3;

FIG. 6 is a side view of the locking device and the portion of the collapsible bicycle in another position than shown in FIG. 5;

FIG. 7 is a side view of the locking device and the portion of the collapsible bicycle in another position than shown in FIG. 6; and

FIG. 8 is another cross-sectional view of the locking device and the portion of the collapsible bicycle shown in FIG. 3.

### DETAILED DESCRIPTION OF PREFERRED EMBODIMENT

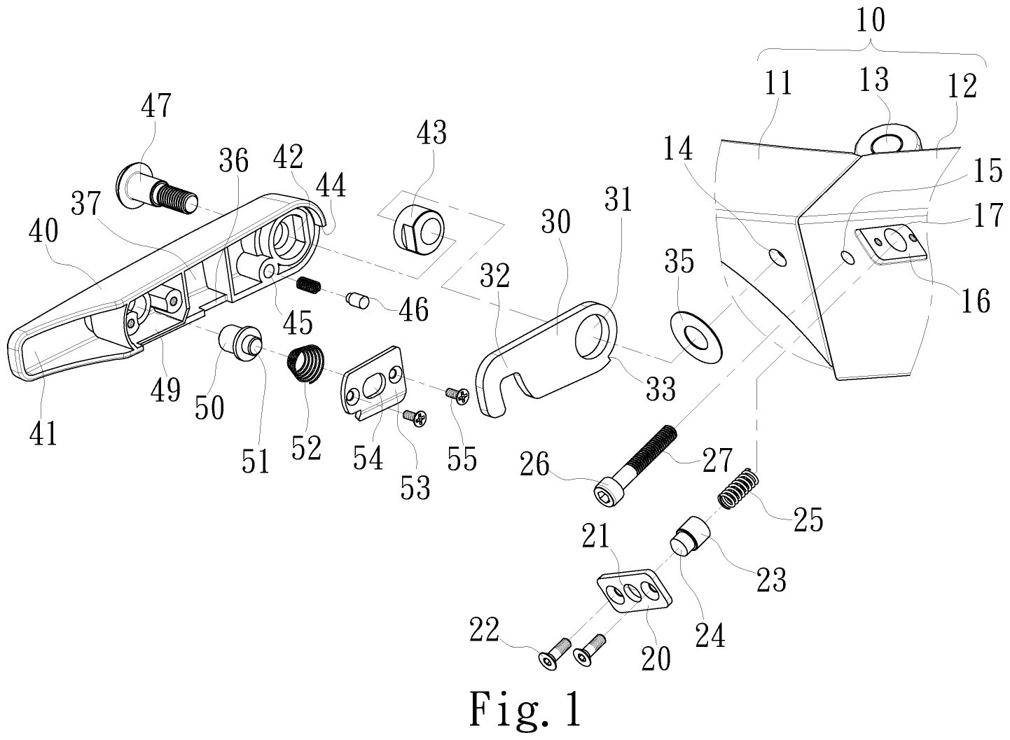

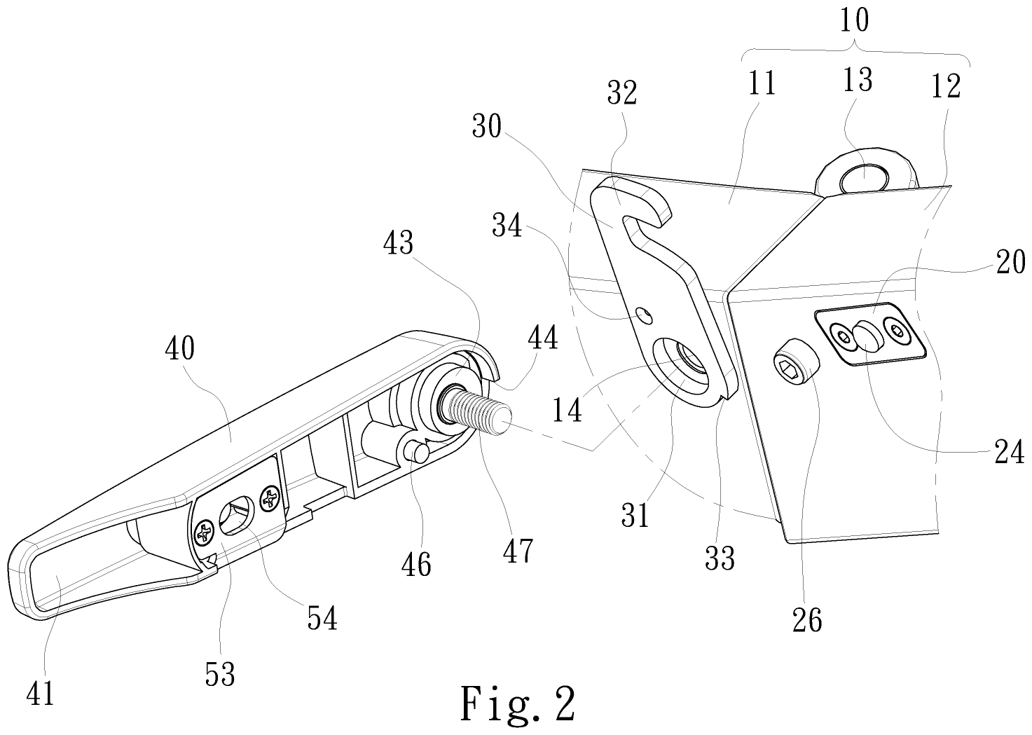

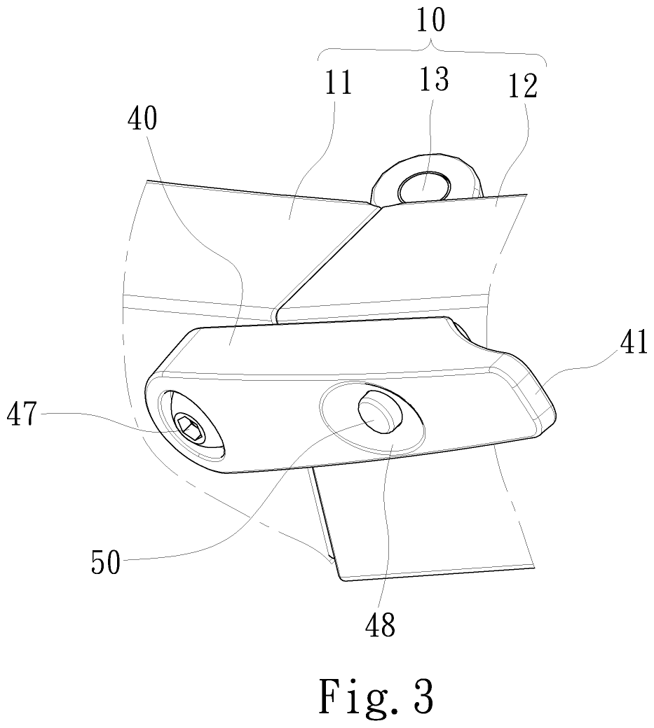

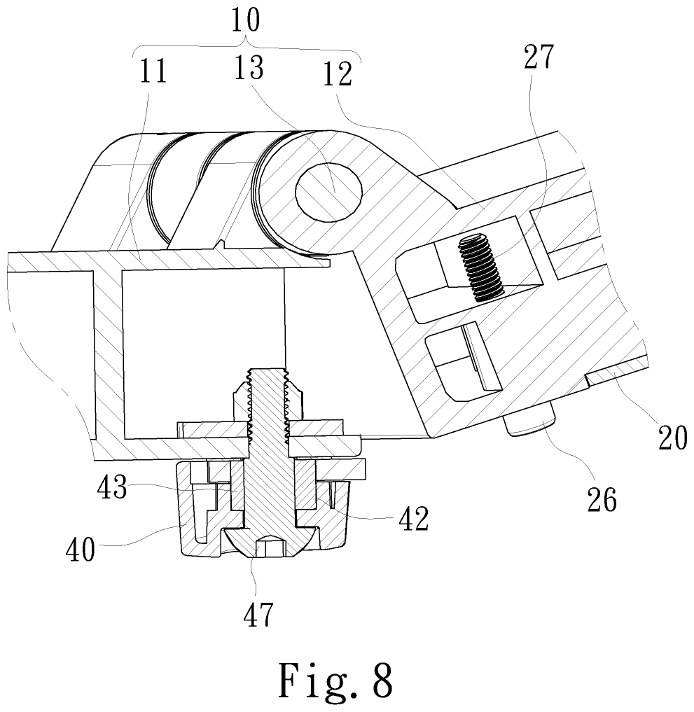

Referring to FIGS. 1 through 4, a locking device according to the preferred embodiment of the present invention is used on a collapsible tube 10 of a collapsible bicycle. The collapsible tube 10 is a top tube, a down tube, a seat tube or a steerer. The collapsible tube 10 includes two sections 11 and 12 pivotally connected to each other by a hinge 13. The sections 11 and 12 are coaxial when the collapsible tube 10 is extended. The sections 11 and 12 are side by side when the collapsible tube 10 is collapsed (FIG. 8). The section 11 includes a screw hole 14. The section 12 includes a screw hole 15, a recess 16 and a cavity 17. Preferably, the recess 16 is a shallow rectangular recess located next to the screw hole 15. A cavity 17 is located within the recess 16. The cavity 17 includes a closed end and an open end in communication with the recess 16.

The locking device includes a detent 23, a positioning element 30, a security element 40, a detent 46, a button 50, a spring 52 and a shackle 53. The positioning element 30 is a flat element that is formed with an orifice 31, a hook 32, a shoulder 33, and a dent 34. The hook 32 extends from an end of the positioning element 30. The shoulder 33 is formed near another end of the positioning element 30. The orifice 31 is located near the shoulder 33. The orifice 31 extends transversely throughout the positioning element 30. The dent 34 is made in a side of the positioning element 30.

The security element 40 is preferably made of synthetic resin by injection molding. The security element 40 is a hollow element that includes a cutout 36, a chamber 37, a lever 41, a space 42, a shoulder 44, a receptacle 45, and a concave portion 49 in a side and a shallow recess 48 in another side. The lever 41 extends from an end of the security element 40. The shoulder 44 is formed at another end of the security element 40 by cutting an edge of the security element 40. The space 42 is a non-circular space located near the shoulder 44. The receptacle 45 is located next to the space 42. The concave portion 49 is located next to the lever 41. The cutout 36 is made by cutting the edge of the security element 40. The chamber 37 is located between the receptable 45 and the concave portion 49. The chamber 37 is in communication with the cutout 36. The security element 40 further includes a channel (not numbered) via which the shallow recess 48 is in communication with the concave portion 49.

The button 50 includes a flange (not numbered) formed thereon, a finger-contacting portion (not numbered) formed on a side of the flange, and a rod 51 extending from another side of the flange. The diameter of the flange of the button of the button 50 is larger than the diameter of the finger-contacting portion and the diameter of the rod 51. A spring 52 is a helical spring. The spring 52 is tapered, i.e., it includes a narrow end and a wide end. The shackle 53 includes a window 54.

The button 50 is inserted in the concave portion 49. The finger-contacting portion of the button 50 extends into the shallow recess 48 from the concave portion 49. The spring 52 is inserted in the concave portion 49. The rod 51 extends through the spring 52. The shackle 53 is attached to the security element 40 by two fasteners 55 for example. The rod 51 extends from the concave portion 49 through the window 54. The spring 52 is compressed between the flange of the button 50 and the shackle 53.

The detent 46 is inserted in the receptacle 45. The detent 46 includes is loaded by a spring (not numbered). Preferably, the detent 46 is in the form of a pin. However, the detent 46 can be in the form of a ball.

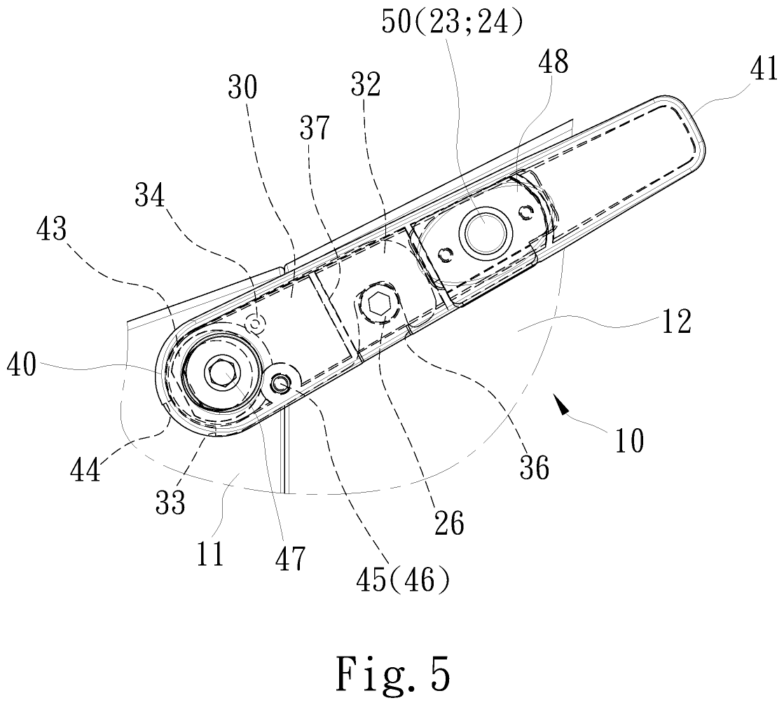

An axle 47 includes a head (not numbered), a smooth section (not numbered) extending from the head, and a threaded section (not numbered) extending from the smooth section. The threaded section of the axle 47 is inserted in the screw hole 14, leaving the head and smooth section of the axle 47 out of the section 11 of the tube 10. The smooth section of the axle 47 extends through an aperture (not numbered) of the cam 43, the orifice 31 of the positioning element 30, and a washer 35. Thus, the axle 47 pivotally connect the security element 40 and the positioning element 30 to the section 11 of the collapsible tube 10. A tip of the detent 46 is abutted against the side of the positioning element 30 in which the detent 34 is made (FIG. 5).

A rod 26 includes a head (not numbered), a smooth section (not numbered) extending from the head, and a threaded section 27 extending from the smooth section. The threaded section 27 of the rod 26 is inserted in the screw hole 15, leaving the head of the rod 26 and the smooth section of the rod 26 out of the section 12 of the tube 10.

A spring 25 is inserted in the cavity 17 before the detent 23 is inserted in the cavity 17. The detent 23 includes an external end 24 and an internal end (not numbered). A plate 20 that includes an aperture 21 is inserted in the recess 16. The plate 20 is connected to the section 12 of the collapsible tube 10 by two screws 22, thereby retaining the spring 25 and a substantial portion of the detent 23 in the cavity 17. The spring 25 is compressed between the closed end of the cavity 17 and the internal end of the detent 23. Thus, the detent 23 is biased by the spring 25. The external end 24 of the detent 23 extends from the cavity 17 via the aperture 21.

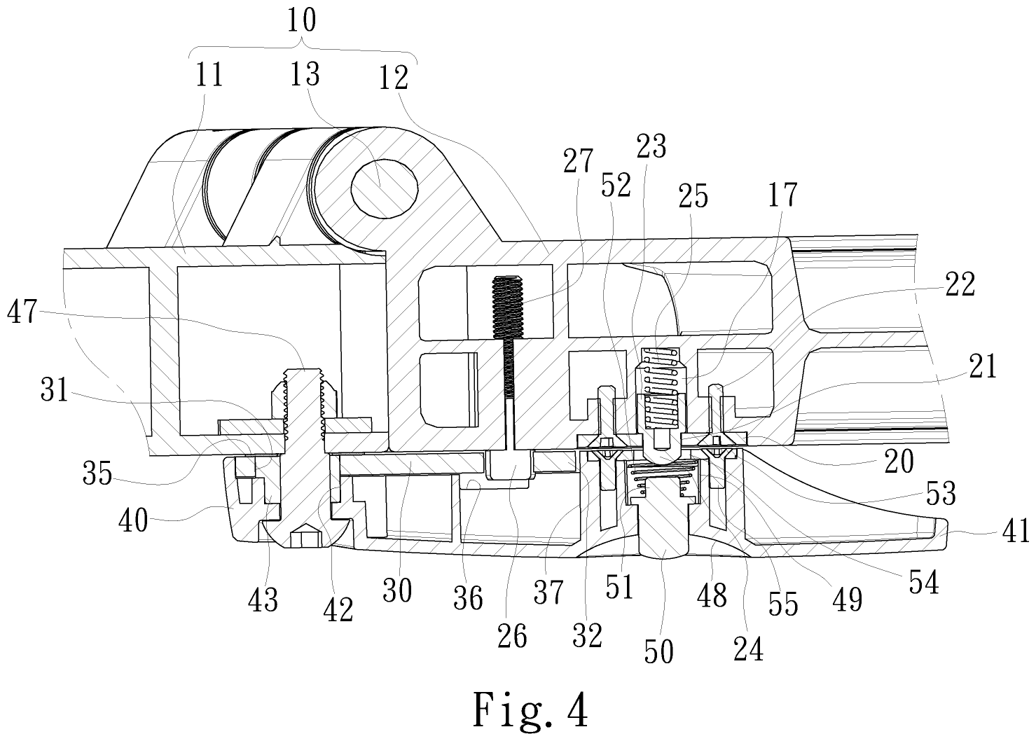

Referring to FIGS. 4 and 5, the external end 24 of the detent 23 extends into the concave portion 49 through the window 54. The external end 24 of the detent 23 is aligned with the rod 51 of the button 50. The rod 26 is inserted in the chamber 37. The chamber 37 is in communication with the exterior of the security element 40 through the cutout 36. The hook 32 is engaged with the rod 26, thereby keeping the sections 11 and 12 coaxial with each other, i.e., keeping the collapsible tube 10 in the extended position. The positioning element 30 is covered and protected from the exterior by the security element 40.

The shallow recess 48 facilitates movement of the finger-contacting portion of the button 50 in the concave portion 49. The flange of the button 50 compresses the spring 52. A tip of the rod 51 of the button 50 extends into the window 54. The tip of the rod 51 moves the external end 24 of the detent 23 in the aperture 21 from the window 54. Thus, the detent 23 releases the security element 40 to allow operation of the lever 41 to pivot the security element 40 relative to the tube 10. The spring 25 is compressed when the detent 23 is moved in the aperture 21 from the window 54.

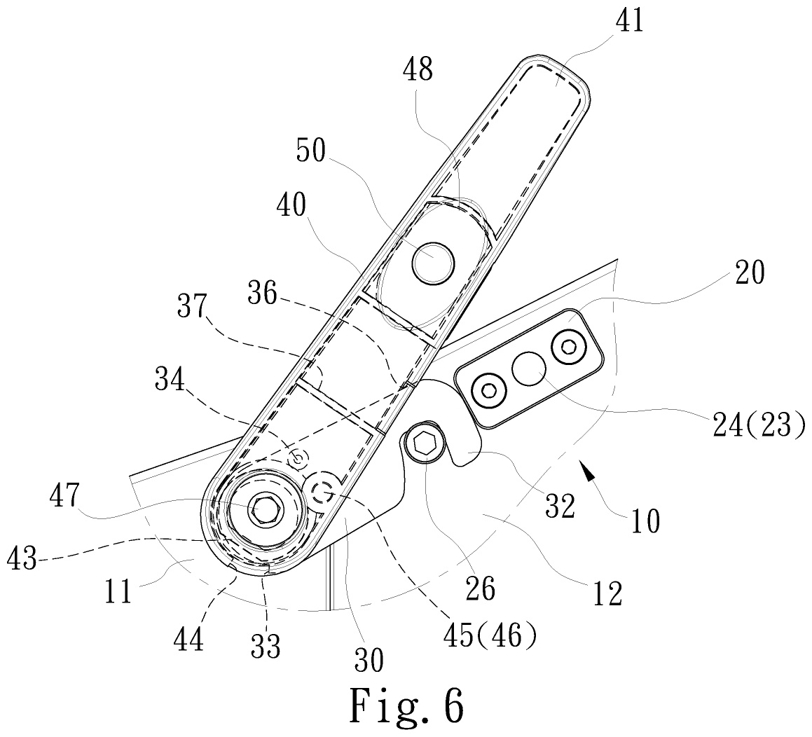

Referring to FIG. 6, the rod 26 is moved through the cutout 36 as the security element 40 is pivoted relative to the tube 10 counterclockwise as shown. The detent 46 is moved from the dent 34 of the positioning element 30. The button 50 can be released when the tip of the rod 51 is moved from the external end 24 of the detent 23. Now, the hook 32 is still engaged with the rod 26. Hence, the sections 11 and 12 are still coaxial with each other. That is, the collapsible tube 10 is still in the extended position. However, the shoulder 44 of the security element 40 is moved toward the shoulder 33 of the positioning element 30.

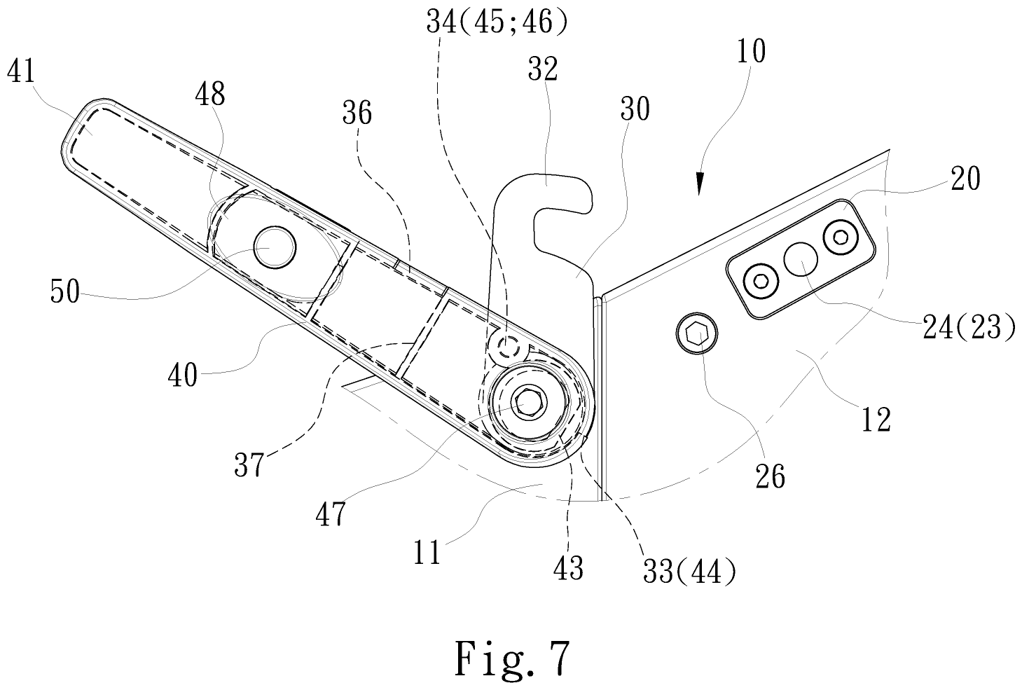

Referring to FIG. 7, the counterclockwise pivoting of the security element 40 continues to bring the shoulder 44 of the security element 40 into contact with the shoulder 33 of the positioning element 30. The detent 46 is inserted in the dent 34. Thus, the security element 40 pivots the positioning element 30 counterclockwise to disengage the hook 32 from the rod 26.

Referring to FIG. 8, the sections 11 and 12 are pivoted relative to each other about the hinge 13. Eventually, the sections 11 and 12 are side by side, i.e., the collapsible tube 10 is collapsed, and the volume is reduced.

In another embodiment, the screw hole 14 can be made in section 12 of the collapsible tube 10, and the screw hole 15, the recess 16, and the cavity 17 can be made in the section 11 of the collapsible tube 10. That is, the detent 23 and the rod 26 are connected to the section 11 of the collapsible tube 10, and the positioning element 30 and the security element 40 are connected to the section 12 of the collapsible tube 10.

The collapsible tube 10 is movable to the extended position again. To keep the collapsible tube 10 in the extended position, the foregoing process is reversed. The detent 46 is inserted in the dent 34 to allow the security element 40 to pivot the positioning element 30 clockwise. Finally, the hook 32 is engaged with rod 26 again. Continued clockwise pivoting of the security element 40 moves the detent 46 from the dent 34. The security element 40 is allowed to pivot relative to the positioning element 30 because the cutout 36 avoids the rod 26. Finally, the security element 40 covers the positioning element 30. The external end 24 of the detent 23 enters the window 54 again, thereby keeping the security element 40 on the positioning element 30.

It should be noted that a cam 43 is used between the positioning element 30 and the security element 40. The cam 43 includes a circular section, a non-circular section, and a circular channel extending through the circular and non-circular sections of the cam 43. The axis of the circular section of the cam 43 is biased from the axis of the circular channel of the cam 43. Thus, the circular section of the cam 43 includes a thin portion on a side of the circular channel of the cam 43 and a thick portion on an opposite side of the circular channel of the cam 43.

The circular section of the cam 43 is inserted in the orifice 31 of the positioning element 30 so that the cam 43 is rotatable relative to the positioning element 30. The non-circular section of the cam 43 is fitted in the space 42 of the security element 40 so that the cam 43 is not rotatable relative to the security element 40. The smooth section of the axle 47 is inserted in the circular channel of the cam 43.

Referring to FIG. 5, a thin portion of the cam 43 is located close to the rod 26 and a thick portion of the cam 43 is located far from the rod 26. Hence, the hook 32 is firmly engaged with the rod 26.

The shoulder 44 is away from the shoulder 33 to allow the counterclockwise pivoting of the security element 40 relative to the positioning element 30 to the position shown in FIG. 6 from the position shown in FIG. 5.

Referring to FIG. 6, the thin portion of the cam 43 is moved away from the rod 26 and the thick portion of the cam 43 is moved toward the rod 26. That is, the hook 32 is moved further from the rod 26 than shown in FIG. 5, thereby reducing the extent to which the hook 32 is engaged with the rod 26. Hence, it is easier to disengage the hook 32 from the rod 26 than shown in FIG. 5.

The counterclockwise pivoting of the security element 40 relative to the positioning element 30 continues to abut the shoulder 44 against the shoulder 33. Thus, the security element 40 is allowed to pivot the positioning element 30, thereby disengaging the hook 32 from the rod 26.

Referring to FIG. 7, the hook 32 is disengaged from the rod 26 to allow pivoting of the sections 11 and 12 of the collapsible tube 10 relative to each other.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A collapsible bicycle comprising:
a collapsible tube comprising a first section, a second section, and a hinge for pivotally connecting the first and second sections to each other;
a spring-loaded detent connected to the second section of the collapsible tube and formed with an external end;
a rod connected to the second section of the collapsible tube;
a positioning element pivotally connected to the first section and formed with a hook engageable with the rod to keep the first and second sections of the collapsible tube coaxial with each other; and
a security element pivotally connected to the first section of the collapsible tube and formed with a concave portion for receiving the spring-loaded detent to keep the security element covering the positioning element, thereby keeping the hook engaged with the rod.

2. The collapsible bicycle according to claim 1, wherein the positioning element comprises a dent, wherein the security element comprises a spring-loaded detent insertable in the dent to allow operation of the security element to pivot the positioning element in an engaging direction to engage the positioning element with the rod.

3. The collapsible bicycle according to claim 1, wherein the positioning element comprises a shoulder, wherein the security element comprises a shoulder engageable with the shoulder of the positioning element to allow operation of the security element to pivot the positioning element in a disengaging direction to disengage the hook from the rod.

4. The collapsible bicycle according to claim 1, comprising a shackle, wherein the security element comprises a concave portion for receiving the shackle, the security element is locked to the collapsible tube when the external end of the spring-loaded detent is inserted in the concave portion via a window in the shackle.

5. The collapsible bicycle according to claim 4, comprising a button inserted in the concave portion and a spring compressed between the button and the shackle to keep a portion of the button out of the security element.

6. The collapsible bicycle according to claim 5, wherein the button comprises a rod aligned to the spring-loaded detent, wherein a free end of the rod moves the external end of the spring-loaded detent from the window of the shackle to allow pivoting of the security element relative to the positioning element when the button is pushed.

7. The collapsible bicycle according to claim 1, wherein the security element comprises a lever operable for pivoting the security element.

8. The collapsible bicycle according to claim 1, wherein the security element is connected to the positioning element so that they are rotatable relative to each other.

9. The collapsible bicycle according to claim 8, wherein the security element comprises a chamber and a cutout in an edge extending around the chamber, wherein the cutout allows movement of the rod into and from the chamber when the security element is rotated relative to the positioning element.

10. The collapsible bicycle according to claim 8, wherein the positioning element comprises a dent, wherein the security element comprises a spring-loaded detent insertable in the dent to allow the security element to pivot the positioning element in an engaging direction to engage the positioning element with the rod, wherein after the engagement of the positioning element with the rod, the spring-loaded detent is moved from the dent to allow pivoting of the security element relative to the positioning element in the engaging direction.

11. The collapsible bicycle according to claim 8, wherein the positioning element comprises a shoulder, wherein the security element comprises a shoulder engaged with the shoulder of the positioning element after the security element is pivoted relative to the positioning element in a disengaging direction for an angle to allow the security element to pivot the positioning element to disengage the hook from the rod.

12. The collapsible bicycle according to claim 8, wherein the positioning element comprises a dent;
wherein the security element comprises a spring-loaded detent insertable in the dent to allow the security element to pivot the positioning element in an engaging direction to engage the positioning element with the rod;
wherein after the engagement of the positioning element with the rod, the spring-loaded detent is moved from the dent to allow pivoting of the security element relative to the positioning element in the engaging direction;
wherein the positioning element comprises a shoulder; and
wherein the security element comprises a shoulder engaged with the shoulder of the positioning element after the security element is pivoted relative to the positioning element in a disengaging direction for an angle to allow the security element to pivot the positioning element to disengage the hook from the rod.

13. The collapsible bicycle according to claim 12, comprising a cam comprising a first section and a second section, wherein the first section of the cam is connected to the security element so that they are rotatable with each other;
wherein the second section of the cam move the positioning element away from the rod to increase a degree of the engagement of the positioning element with the rod when the security element is pivoted relative to the positioning element in the engaging direction; and
wherein the second section of the cam move the positioning element toward the rod to reduce the degree of the engagement of the positioning element with the rod when the security element is pivoted relative to the positioning element in the disengaging direction.

14. The collapsible bicycle according to claim 13, comprising an axle comprising a section inserted in the first section of the collapsible tube and another section inserted in the cam.

15. The collapsible bicycle according to claim 13, wherein the security element comprises a non-circular space, wherein the first section of the cam is a non-circular section fitted in the non-circular space.

16. The collapsible bicycle according to claim 13, wherein the positioning element comprises an orifice for receiving the second section of the cam.

17. The collapsible bicycle according to claim 13, comprising an axle comprising a section inserted in the first section of the collapsible tube and another section inserted in the cam, wherein the positioning element comprises an orifice for receiving the second section of the cam.

18. The collapsible bicycle according to claim 17, comprising an axle comprising a section inserted in the first section of the collapsible tube and another section inserted in the cam.
